(19) United States
(12) Patent Application Publication
(10) Pub. No.: US 2007/0003398 A1
(43) Pub. Date: Jan. 4, 2007

(54) Utility trailer having a removable storage unit and method of using the same

(76) Inventor: Mark S. Hernandez, Philadelphia, PA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/477,897

(22) Filed: Jun. 28, 2006

Related U.S. Application Data
(60) Provisional application No. 60/694,717, filed on Jun. 28, 2005.

(51) Int. Cl. B60P 1/04

(52) U.S. Cl. 414/483

(57) ABSTRACT

A trailer having a base frame and an upper frame, the base frame adapted to be removably secured to a vehicle, while the upper frame having a rear end and a forward end is pivotally connected along its intermediate length to the base frame. The upper frame incorporates a pair of spaced axles having dual wheels on both ends of the axles, as well as a winch assembly. The upper frame also incorporates slidably moving means to move a container relative thereto. A hydraulic cylinder is operably and pivotally mounted between the upper frame and base frame to enable the upper frame to be moved between a first position and a second position relative to the base frame. The upper frame is pivotally connected to the base frame such that the upper frame can tilt from a first position, the length of which is substantially parallel to the length of the base frame, to a second position where the upper frame is tilted. In the second position, a container that is located at ground level can be easily loaded onto the upper frame. A forward portion of the container engages the rear end of the upper frame and is displaced along the length of the upper frame using slidably moving means and the winch assembly.

### CROSS-REFERENCE TO RELATED APPLICATIONS

The present application claims the benefit of U.S. Provisional Patent Application 60/694,717, filed Jun. 28, 2005, the entirety of which is hereby incorporated by reference.

### FIELD OF INVENTION

The present invention relates to utility trailers and particularly to a trailer frame having a removable storage unit.

### BACKGROUND OF THE INVENTION

There are devices that allow for the storage and transportation of various bulky items and the like. Utility trailers, for example, are typically coupled to trucks, cars or other vehicles and are used to transport various types of goods including automobiles, motorcycles, furniture, household goods and other items. Some utility trailers have protective enclosures, and can include a trailer bed having an undercarriage, axles and wheels attached thereto. A hitch, for connecting the trailer to a towing vehicle, is often times attached to the front of the trailer bed chassis. The protective enclosure is typically a box-like structure covering the trailer bed and secured to the chassis, which would include doors which permit access to the interior of the enclosure.

As an alternative to utility trailers, users may utilize rental trucks having permanently attached enclosures to transport items from location to location. There are, however, drawbacks in using utility trailers and rental trucks as previously described. In many instances, such utility trailers and trucks do not facilitate the extended storage of goods (rather, they facilitate the transportation of goods) and are bulky to situate in close proximity to, for example, a house or construction site. If a person desires to store goods for an extended period of time, such a person generally transports the person's goods to a storage facility and perhaps uses a utility trailer or rental truck to transport such goods.

There are stand-alone storage containers, however, that can be rented for a period of time (e.g., week, month). Such storage containers are handled and transported through special carrier frames systems, which are complex to operate. A person handling such a carrier frame would be in need of specialized training. Thus, the renter of such a stand-alone storage container would not be capable of operating such a carrier frame system without specialized training. Instead, a operator with specialized training is needed to handle and transport (usually in conjunction with a vehicle) such a stand-alone container. Generally, the entity supplying a stand-alone container would employ such an operator to handle and transport the rented container. Thus, one drawback is that a user is constrained by time and availability limitations of the operators employed by the entity supplying the storage containers as well as that of the carrier frame systems

Accordingly, there is a need to have an improved containment system capable of storing goods that is easily transportable by the user at the discretion of the user.

### SUMMARY OF THE INVENTION

It is therefore an object of the present invention to provide a trailer frame capable of handling and transporting a container and a method of using the same.

Another object of the present invention is to provide a trailer frame with removable container and a method of using the same.

Yet another object of the present invention is to provide a trailer frame with a removable container that facilitates in the handling and transportation of goods and a method of using the same.

These and other objects are addressed by the present invention, which is in one aspect a trailer having a base frame; an upper frame comprising a rear end, a forward end, and slidably moving means to move a container along the length of the upper frame, the upper frame pivotally connected about a pivot point to the base frame; a winch assembly secured to the upper frame; and a hydraulic assembly pivotally mounted between the base frame and the upper frame, the hydraulic assembly adapted to move the upper frame relative to the base frame about the pivot point between a generally horizontal position and a tilted position, wherein the upper frame in the tilted position is adapted to receive a container through the slidably moving means. In one embodiment, the hydraulic assembly comprises a powered hydraulic cylinder and a piston rod operably connected to the powered hydraulic cylinder, the piston rod capable of being extended from the powered hydraulic cylinder.

In another embodiment, the slidably moving means comprises a channel to operably engage a wheel secured to the container when the upper frame is in the tilted position. Preferably the slidably moving means comprises two channels, each of the two channels capable of operably engaging a wheel secured to the container when the upper frame is in the tilted position. In such an embodiment, the winch assembly comprises a winch wire operably connected to a winch drum, the winch wire having a first end and a second end, wherein the winch wire at the first end is operably connected to the winch drum, the second end capable of being removably secured to the container, whereby the winch assembly actuates loading of the container onto the upper frame.

In yet another embodiment, the present invention further comprises a securing device secured to the base frame for removable connection to a vehicle. In a further embodiment, the present invention comprises a jack support connected to the base frame, the jack support comprising a support member slidably housed within a sleeve, the support member capable of being extended to a predetermined length, the support member at one end pivotally connected to a base capable of engaging the ground.

In another aspect, the present invention is a trailer assembly comprising a base frame; an upper frame comprising a rear end and a forward end, the upper frame pivotally connected about a pivot point to the base frame; a container removably secured to the upper frame, the container having a plurality of side walls, a roof, a floor, and a plurality of wheels connected to an exterior portion of the floor, wherein the upper frame further comprises slidably moving means to move the container along the length of the upper frame; a winch assembly secured to the upper frame, the winch assembly comprising a winch wire operably connected to a winch drum at one end of the winch wire, the other end of the winch wire capable of being removably secured to the container; and a hydraulic assembly pivotally mounted between the base frame and the upper frame, the hydraulic assembly adapted to move the upper frame relative to the base frame about the pivot point between a generally horizontal position and a tilted position where the rear end is positioned adjacent to the ground, whereby, when the upper frame is in the tilted position, the winch assembly and the slidably moving means actuate loading of the container onto the upper frame or unloading of the container from the upper frame.

In one embodiment, the slidably moving means comprises a channel to operably engage a wheel secured to the container when the upper frame is in the tilted position. In a further embodiment, the present invention also comprises a jack support connected to the base frame, the jack support comprising a support member slidably housed within a sleeve, the support member capable of extending the jack support to a predetermined length, the support member at one end pivotally connected to a base capable of engaging the ground.

In yet another aspect, the present invention is a method of handling a container comprising the steps of: a) positioning a trailer adjacent to the container, the trailer comprising a base frame, an upper frame comprising a rear end, a forward end, and means to slidably move a container along the length of the upper frame, the upper frame pivotally connected about a pivot point to the base frame, a winch assembly secured to the upper frame, and a hydraulic assembly pivotally mounted between the base frame and the upper frame, the hydraulic assembly adapted to move the upper frame relative to the base frame about the pivot point between a generally horizontal position and a tilted position where the rear end is positioned adjacent to the ground, and wherein the container comprises a plurality of side walls, a roof, a floor, and a plurality of wheels connected to an exterior portion of the floor; b) tilting the upper frame to the tilted position where the rear end is positioned adjacent to the ground; c) engaging the container with the slidably moving means of the upper frame; d) securing a winch line at one end to the container and at another end to a winch drum, the winch assembly comprising the winch line and the winch drum; e) activating the winch assembly to actuate loading of the container onto the upper frame through use of the slidably moving means; and f) loading the container onto the upper frame.

In one embodiment, the slidably moving means comprises a channel to operably engage a wheel secured to the container when the upper frame is in the tilted position. In yet another embodiment, the present invention additionally comprises the step of positioning the upper frame in a generally horizontal position relative to the base frame after the container is loaded onto the upper frame. In a further embodiment, the trailer further comprises a jack support connected to the base frame, the jack support comprising a support member slidably housed within a sleeve, the support member capable of extending the jack support to a predetermined length, the support member at one end pivotally connected to a base capable of engaging the ground.

### BRIEF DESCRIPTION OF THE DRAWINGS

FIG. 1 is a side view of the trailer frame of the present invention in a generally horizontal position;

FIG. 2 is a bottom view of the trailer frame of the present invention;

FIG. 3 is a side view of the trailer frame of the present invention in a tilted position;

FIG. 4 is a rear perspective view of the trailer frame of the present invention in a tilted position;

FIG. 5 is a side view of the present invention illustrating a container being loaded onto the trailer frame;

FIG. 6 is a detailed perspective view illustrating wheels of the container operatively engaged with a channel according to one aspect of the present invention.

FIG. 7 is a side view of a container of the present invention;

FIG. 8 is a rear view of a container of the present invention; and

FIG. 9 is a side view of the trailer frame in the horizontal position supporting a container.

### DETAILED DESCRIPTION OF THE INVENTION

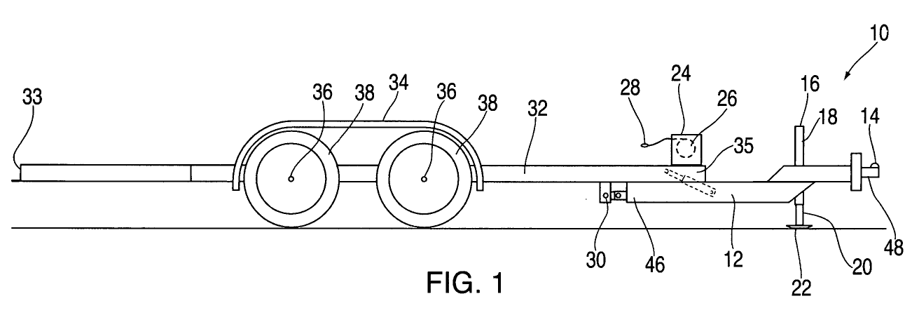

As explained in more detail below and referring to FIGS. 1-6, in one embodiment the present invention generally comprises a trailer frame 10 pivotally connected to an upper frame 32 along the intermediate length of the upper frame 32. In one embodiment, a container 50 having castors 6 attached thereto can be removably secured to the upper frame 32.

FIG. 1 illustrates the trailer frame 10 of the present invention, which is designed to be pulled by a conventional car, truck or other vehicle. The trailer 10 includes a base frame 12 comprised of generally longitudinal extending members 80, 86 interconnected through generally horizontal bisecting members 82, 84, 88, 90. The longitudinal extending members 80, 86 and horizontal bisecting members 82, 84, 88, 90 can be of any desired configuration. In addition to such members, however, the base frame 12 can be comprised of other structural members as desired or required to support a load thereon.

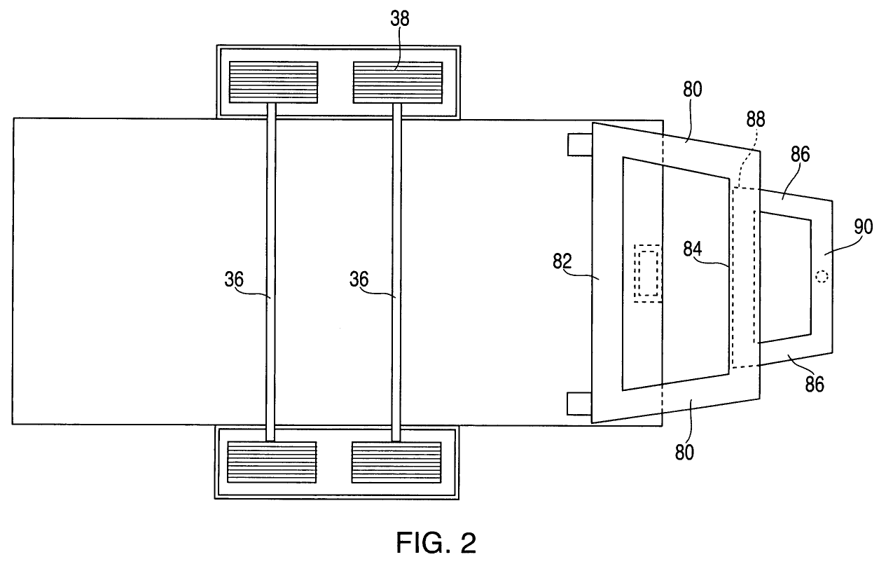

Referring to FIG. 2, however, in a preferred embodiment, the base frame 12 comprises two first opposed and generally longitudinal members 80 bisected by a first horizontal member 82 at their rearward end and a second horizontal member 84 at their forward end. The second horizontal member 84 is shorter in length than the first horizontal member 86 which has the effect of causing the first opposed longitudinal members 80 to slant. The first opposed longitudinal members 80, second horizontal member 84 and first horizontal member 86 are interconnected in such a way as to generally form a trapezoid shape. A third horizontal member 88 is secured to the upper portion of the second horizontal member 84 in an overlapping fashion, the third horizontal member 88 equal to or slightly shorter in length than the second horizontal member 84. Two second opposed longitudinal members 86 at their rearward ends are connected to the third horizontal member 88. The second opposed longitudinal members 86 at their forward ends are then connected to a fourth horizontal member 90, the fourth horizontal member 90 shorter in length than the third horizontal member 88. The second opposed longitudinal members 86, third horizontal member 88 and fourth horizontal member 90 are interconnected in such a way as to generally form a trapezoid shape.

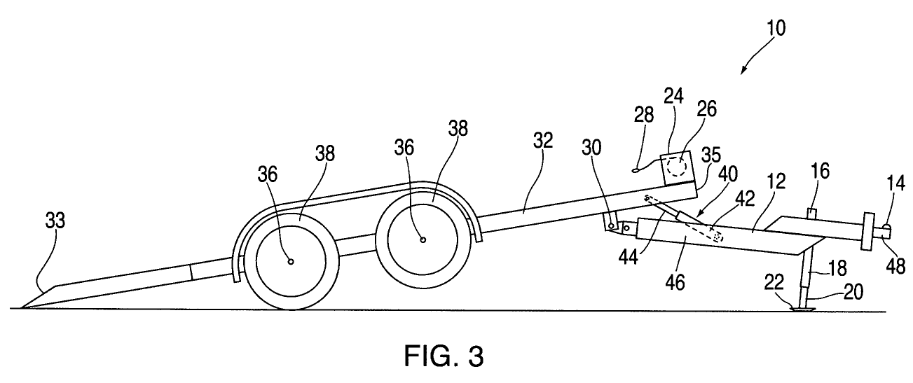

Referring to FIGS. 1 and 3, the base frame 12 has a front end 48 and a rear end 46. The front end 48 is capable of being removably secured to a portion of a vehicle (not shown) using a hitch 14 positioned on the front end of the base frame 12. In one embodiment, a jack support 16 is operably connected to the base frame 12. The jack support 16 comprises a sleeve 18, a support member 20 partially or fully housed within the sleeve 18, and a base 22 to engage the ground or other supporting reference such as a platform. Preferably, the support jack 16 is located substantially central to the base frame 12 such that both the second horizontal member 84 and the third horizontal member 88 are operably connected to the jack support 16. In use, the base 22 is pivotally connected to the support member 20 so that the base 22 can substantially engage the ground even when the support member 20 is positioned at different angles relative to the ground or the base 22. The support member 20 is capable of being extended from within the sleeve 18 to a length that allows the base to substantially engage the ground, a platform, or the like.

As will be explained in greater detail below, the jack support 16 can be extended using the support member 20 (preferably when the upper frame 32 is tilted in relation to the base frame 12 because the jack support 16 can provide extra support for the trailer frame 10). The support member 20 can otherwise partially retract within the sleeve 18 such that the base 22 does not engage the ground, which is important when the trailer frame 10 with or without container 50 is moving or being towed by a vehicle.

Referring back to the base frame 12, the rear end 46 of the base frame 12 is pivotally connected at pivot point 30 to an upper frame 32 along the intermediate length of upper frame 32. The upper frame 32 is comprised of longitudinal extending members interconnected through generally horizontal bisecting members, the interconnected upper frame members forming a substantially rectangular arrangement having a forward end 35 and a rear end 33. It is understood, however, that the upper frame 32 can be comprised of other structural members as desired or required to support a load thereon. Optionally, a upper frame support surface can be secured to the interconnected upper frame members to provide added support for items loaded onto the upper frame 32.

The upper frame 32 incorporates a pair of spaced axles 36 having dual wheels 38 on both ends of the axles 36. A suspension assembly (not shown) is capable of operably supporting and connecting the axles 36 such that the dual wheels 38 are provided on both sides of the upper frame 32. The upper frame 32 can also incorporate a winch assembly 24. The winch assembly 24 comprises a winch wire 28 that can be wound around a winch drum 26, the winch wire 28 capable of extending in length past the length of the upper frame 32 and being secured to a container 50 or the like. The winch assembly 24 can be powered using an electrical source from an associated vehicle or through a separate power source. Alternatively, the winch assembly can be operated manually.

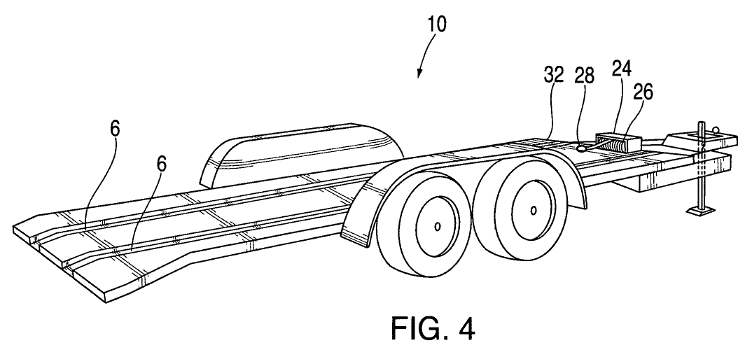

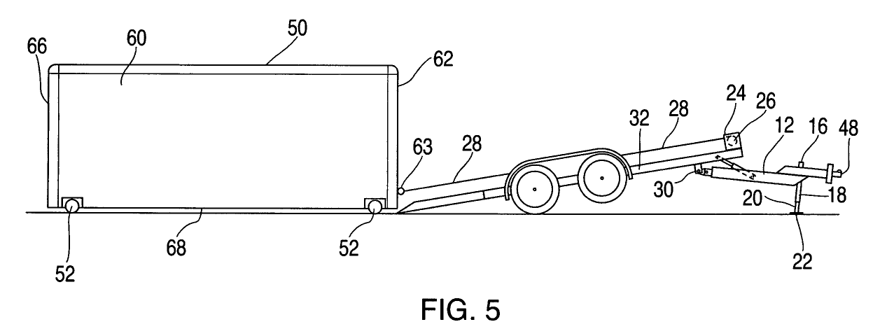

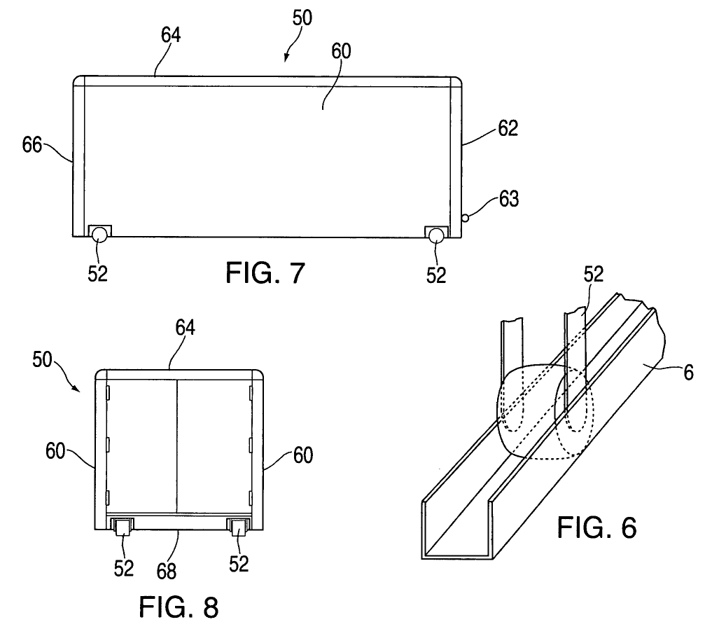

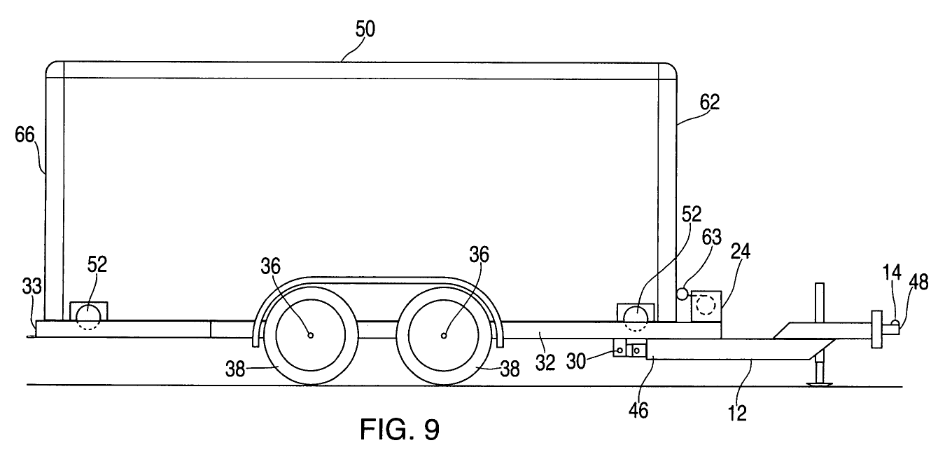

The upper frame 32 also incorporates slidably moving means to move the container 50, the slidably moving means comprising, in a preferred embodiment as illustrated in FIGS. 4 and 5, two channels 6 that extend parallel along the length of upper frame 32. The channels 6 are preferably 1-5 inches deep and 1-5 inches wide. However, any depth and width of the channels 6 may be incorporated in the upper frame 32 that corresponds to castors 52 attached to the container 50, which, when the castors 52 are engaged with the channels 6, actuate movement of the container 50 along the length of the upper frame 32 for loading and loading of the container 50. Although, in the preferred embodiment, two channels 6 are described, it is also within the scope of the invention to have only one channel or a plurality of channels, so long as the channel or channels in conjunction with the castors 52 actuate movement of the container 50 along the length of the upper frame 32. It is also within the scope of the invention to provide for other ways to actuate movement of the container 50 along the length of the upper frame 32 for loading and unloading. The upper frame 32 can incorporate one or more propulsion tracks that engages a bottom portion of the container in a way such that the storage unit is propelled in a predetermined direction. The propulsion track can be comprised of a material which is preferably flexible yet sturdy enough to maintain engagement of the container. Material may include but is not limited to vulcanized rubber, steel, aluminum or composites. Such propulsion tracks are similar in operation to tank treads and may optionally have projecting cleats which will engage a bottom portion of the container and aid in propelling or driving the unit in a desired direction.

A hydraulic assembly 40 as shown is FIGS. 3 and 5, comprised of a hydraulic cylinder 42 and a piston rod 44 capable of extending from the hydraulic cylinder 42, is operably and pivotally mounted between the upper frame 32 and base frame 12. The extension and retraction of the piston rod 44 from the hydraulic cylinder 42 enable the upper frame 32 to be moved between a first position (as illustrated in FIG. 1) and a second position (as illustrated in FIG. 3) relative to the base frame 12. More specifically, the upper frame 32 is pivotally connected to the base frame 12 such that the upper frame 32 can tilt from a first position, the length of which is substantially parallel to the length of the base frame 12, to a second position where the rear end 33 of the upper frame 32 can engage or be in close proximity to the ground or the like. The hydraulic assembly 40 can be of any variety including but not limited to a pneumatic hydraulic assembly or, in a preferred embodiment, a powered hydraulic assembly.

Referring to FIG. 5, in the second position, a container 50 that is located at or in close proximity to ground level can be easily loaded onto the upper frame 32. A forward portion of the container 50 engages the rear end 33 of the upper frame 32. Referring to FIG. 6, castors 52 attached to the bottom of the container 50 engage the channels 6, where the castors 52 moving along the channel allow for the container 50 to be displaced along the length of the upper frame 32. The loading of the container 50 is performed using the winch assembly 24 where the winch wire 28 is extended to reach and to be secured to the container 50, preferably, close to the base of the container 50. The winch assembly 24 is then activated and the winch drum 26 spools the winch wire 28 back along with the container 50 towards the winch assembly 24. Unloading the container 50 can also be performed in a similar fashion where the winch drum 26 unspools the winch wire 28 from the winch assembly 24 at a controlled rate. Aided by the effect of gravity, the container 50 can roll down the length of the upper frame 32, which is in the tilted position, through use of the castors 52 operatively engaging the channels 6.

The container 50 is comprised of two side walls 60, a front wall 62 having a securing device 63 to secure the winch wire 28, a rear wall 66, a roof 64 and a floor 68. The rear wall 66 may be comprised of a door, a plurality of doors, sealable apertures or the like. In the preferred embodiment, the container 50 of present invention is substantially formed as a single piece in order to minimize the occurrence of breaches in the protective covering afforded by the container 50. It is within the scope of the present invention, however, to include a container 50 that is constructed in a modular fashion that may include individually formed walls 60, 62, 66, roof 64, floor 68 or a combination thereof and that are joined together through a variety of methods including but not limited to welding. The container 50 can be constructed of material that protects the contents of the trailer, such as fiberglass, aluminum, metal, composites or other suitable materials. The shape of the container 50 can be any shape suitable for enclosing and protecting its contents. Furthermore, the container 50 may incorporate a variety of devices to facilitate movement of the storage unit including, but not limited to, skids, castors, steel bearing wheels, omni wheels, or other suitable devices. Preferably, castors 52 are located on the underside of the container 50, secured to the exposed exterior portion of the floor 68. It is preferred that four casters 52 are positioned generally around the four corners of the floor 68 such that the pair of castors 52 running along the length of the container are in line with one of the channels 6.

The container 50 allows for storage of items when the container is either loaded onto the trailer frame 10 or when the container unit is not loaded onto and separate from the trailer frame 10 as a stand-alone unit. Furthermore, the trailer frame 10 and container 50 of the present invention affords the user the convenience of placing items within the storage unit at the user's leisure as well as transporting the storage unit at the user's leisure, since the present invention allows for a user to releasably attach the utility trailer to a vehicle for towing. Accordingly, the user does not have to drive or hire a third party to drive bulky storage trucks or the like and may, instead, utilize the user's private vehicle or a similar type of vehicle. Additionally, the user does not have to rely on a storage container moving services, which are many times unreliable and are limited in their availability.

Whereas the present invention has been described in relation to the accompanying drawings, it should be understood that other and further modifications, apart from those shown or suggested herein, may be made within the spirit and scope of the present invention. It is also intended that all matter contained in the foregoing description or shown in the accompanying drawings shall be interpreted as illustrative rather than limiting.

What is claimed is:

1. A trailer comprising:
a base frame;
an upper frame comprising a rear end, a forward end, and slidably moving means to move a container along the length of the upper frame, the upper frame pivotally connected about a pivot point to the base frame;
a winch assembly secured to the upper frame; and
a hydraulic assembly pivotally mounted between the base frame and the upper frame, the hydraulic assembly adapted to move the upper frame relative to the base frame about the pivot point between a generally horizontal position and a tilted position,
wherein the upper frame in the tilted position is adapted to receive a container through the slidably moving means.

2. The trailer of claim 1, wherein the hydraulic assembly comprises a powered hydraulic cylinder and a piston rod operably connected to the powered hydraulic cylinder, the piston rod capable of being extended from the powered hydraulic cylinder.

3. The trailer of claim 1, wherein the slidably moving means comprises a channel to operably engage a wheel secured to the container when the upper frame is in the tilted position.

4. The trailer of claim 3, wherein the winch assembly comprises a winch wire operably connected to a winch drum, the winch wire having a first end and a second end, wherein the winch wire at the first end is operably connected to the winch drum, the second end capable of being removably secured to the container, whereby the winch assembly actuates loading of the container onto the upper frame.

5. The trailer of claim 1, further comprising a securing device secured to the base frame for removable connection to a vehicle.

6. The trailer of claim 1, further comprising a jack support connected to the base frame, the jack support comprising a support member slidably housed within a sleeve, the support member capable of being extended to a predetermined length, the support member at one end pivotally connected to a base capable of engaging the ground.

7. The trailer of claim 3, wherein the slidably moving means comprises two channels, each of the two channel capable of operably engaging a wheel secured to the container when the upper frame is in the tilted position.

8. A trailer assembly comprising:
a base frame;
an upper frame comprising a rear end and a forward end, the upper frame pivotally connected about a pivot point to the base frame;
a container removably secured to the upper frame, the container having a plurality of side walls, a roof, a floor, and a plurality of wheels connected to an exterior portion of the floor, wherein the upper frame further comprises slidably moving means to move the container along the length of the upper frame;
a winch assembly secured to the upper frame, the winch assembly comprising a winch wire operably connected to a winch drum at one end of the winch wire, the other end of the winch wire capable of being removably secured to the container; and
a hydraulic assembly pivotally mounted between the base frame and the upper frame, the hydraulic assembly adapted to move the upper frame relative to the base frame about the pivot point between a generally horizontal position and a tilted position where the rear end is positioned adjacent to the ground,
whereby, when the upper frame is in the tilted position, the winch assembly and the slidably moving means actuate loading of the container onto the upper frame or unloading of the container from the upper frame.

9. The trailer assembly of claim 8, wherein the hydraulic assembly comprises a powered hydraulic cylinder and a piston rod operably connected to the powered hydraulic cylinder, the piston rod capable of being extended from the powered hydraulic cylinder.

10. The trailer assembly of claim 8, wherein the slidably moving means comprises a channel to operably engage a wheel secured to the container when the upper frame is in the tilted position.

11. The trailer assembly of claim 8, further comprising a securing device secured to the base frame for removable connection to a vehicle.

12. The trailer assembly of claim 8, further comprising a jack support connected to the base frame, the jack support comprising a support member slidably housed within a sleeve, the support member capable of extending the jack support to a predetermined length, the support member at one end pivotally connected to a base capable of engaging the ground.

13. A method of handling a container comprising the steps of:
a) positioning a trailer adjacent to the container, the trailer comprising a base frame, an upper frame comprising a rear end, a forward end, and means to slidably move a container along the length of the upper frame, the upper frame pivotally connected about a pivot point to the base frame, a winch assembly secured to the upper frame, and a hydraulic assembly pivotally mounted between the base frame and the upper frame, the hydraulic assembly adapted to move the upper frame relative to the base frame about the pivot point between a generally horizontal position and a tilted position where the rear end is positioned adjacent to the ground, and wherein the container comprises a plurality of side walls, a roof, a floor, and a plurality of wheels connected to an exterior portion of the floor;
b) tilting the upper frame to the tilted position where the rear end is positioned adjacent to the ground;
c) engaging the container with the slidably moving means of the upper frame;
d) securing a winch line at one end to the container and at another end to a winch drum, the winch assembly comprising the winch line and the winch drum;
e) activating the winch assembly to actuate loading of the container onto the upper frame through use of the slidably moving means; and
f) loading the container onto the upper frame.

14. The method of claim 13, wherein the slidably moving means comprises a channel to operably engage a wheel secured to the container when the upper frame is in the tilted position.

15. The method of claim 13, further comprising the step of positioning the upper frame in a generally horizontal position relative to the base frame after the container is loaded onto the upper frame.

16. The method of claim 13, wherein the trailer further comprises a jack support connected to the base frame, the jack support comprising a support member slidably housed within a sleeve, the support member capable of extending the jack support to a predetermined length, the support member at one end pivotally connected to a base capable of engaging the ground.
